(19) United States
(12) Patent Application Publication
(10) Pub. No.: US 2023/0188827 A1
(43) Pub. Date: Jun. 15, 2023

(54) ELECTRONIC DEVICE, CONTROL METHOD OF ELECTRONIC DEVICE, AND NON-TRANSITORY COMPUTER READABLE MEDIUM

(71) Applicant: CANON KABUSHIKI KAISHA, Tokyo (JP)

(72) Inventor: Taku ITO, Kanagawa (JP)

(21) Appl. No.: 18/063,178

(22) Filed: Dec. 8, 2022

(30) Foreign Application Priority Data
Dec. 13, 2021 (JP) 2021-201809

(51) Int. Cl. H04N 23/611; H04N 23/60; H04N 23/63; G06V 40/19; G06V 40/20; H04N 5/77

(52) U.S. Cl. CPC H04N 23/611; H04N 23/64; H04N 23/63; G06V 40/19; G06V 40/20; H04N 5/77

(57) ABSTRACT

An electronic device according to the present invention includes at least one memory and at least one processor which function as: an acquisition unit configured to acquire eyeball information of a user; and a recording unit configured to, on a basis of the eyeball information acquired by the acquisition unit, record an image corresponding to a field of view of the user, in a case where a state of the user satisfies a predetermined condition.

### BACKGROUND OF THE INVENTION

### Field of the Invention

The present invention provides an electronic device, a control method of the electronic device, and a non-transitory computer readable medium

### Description of the Related Art

In a case where a user utilizing an electronic device such as a camera, smart glasses or a head-mounted display is focused on visually recognizing scenery or content, it is difficult for the user to deliberately designate a timing (recording timing) for recording (acquiring) a highlight. Accordingly, the recording timing may be determined automatically.

As a method for automatically determining a recording timing, for instance Japanese Patent Application Publication No. 2012-113609 discloses a method for determining a recording timing on the basis of the nervousness of a user. Japanese Patent Application Publication No. 2009-17598 discloses a method for determining a recording timing on the basis of the movement of an electronic device.

However, in the methods disclosed in Japanese Patent Application Publication Nos. 2012-113609 and 2009-17598, instances may occur in which a highlight is not recorded, even if the user wishes to do so, since the recording timing is determined on the basis of the nervousness of the user or the movement of an electronic device.

### SUMMARY OF THE INVENTION

The present invention provides a technique to record highlights on the basis of the state of a user.

The present invention in its first aspect provides an electronic device including at least one memory and at least one processor which function as: an acquisition unit configured to acquire eyeball information of a user; and a recording unit configured to, on a basis of the eyeball information acquired by the acquisition unit, record an image corresponding to a field of view of the user, in a case where a state of the user satisfies a predetermined condition.

The present invention in its second aspect provides a control method of an electronic device, including: acquiring eyeball information of a user; and recording an image corresponding to a field of view of the user, in a case where a state of the user satisfies a predetermined condition, on a basis of the eyeball information.

The present invention in its third aspect provides a non-transitory computer readable medium that stores a program, wherein the program causes a computer to execute a control method of an electronic device, the control method including: acquiring eyeball information of a user; and recording an image corresponding to a field of view of the user, in a case where a state of the user satisfies a predetermined condition, on a basis of the eyeball information.

Further features of the present invention will become apparent from the following description of exemplary embodiments with reference to the attached drawings.

### BRIEF DESCRIPTION OF THE DRAWINGS

FIG. 1A to FIG. 1C are external-view diagrams of a camera according to Embodiment 1;

FIG. 2 is a block diagram of a camera according to Embodiment 1;

FIG. 3 is a block diagram of smart glasses according to Embodiment 1;

FIG. 4 is a flowchart of setting processing of a highlight recording flag according to Embodiments 1 and 2;

FIG. 5 is a flowchart of recording processing of a highlight still image according to Embodiment 1;

FIG. 6 is a flowchart of recording processing of a highlight moving image according to Embodiment 1;

FIG. 7 is a diagram illustrating a highlight moving image according to Embodiment 1;

FIG. 8 is a block diagram of a head-mounted display according to Embodiment 2;

FIG. 9 is a flowchart of recording processing of a highlight still image according to Embodiment 2; and

FIG. 10 is a flowchart of recording processing of a highlight moving image according to Embodiment 2.

### DESCRIPTION OF THE EMBODIMENTS

### Embodiment 1

Embodiment 1 of the present invention will be explained below with reference to the accompanying drawings. As Embodiment 1, an instance will be explained in which the present invention is applied to a camera or smart glasses.

Configuration Description

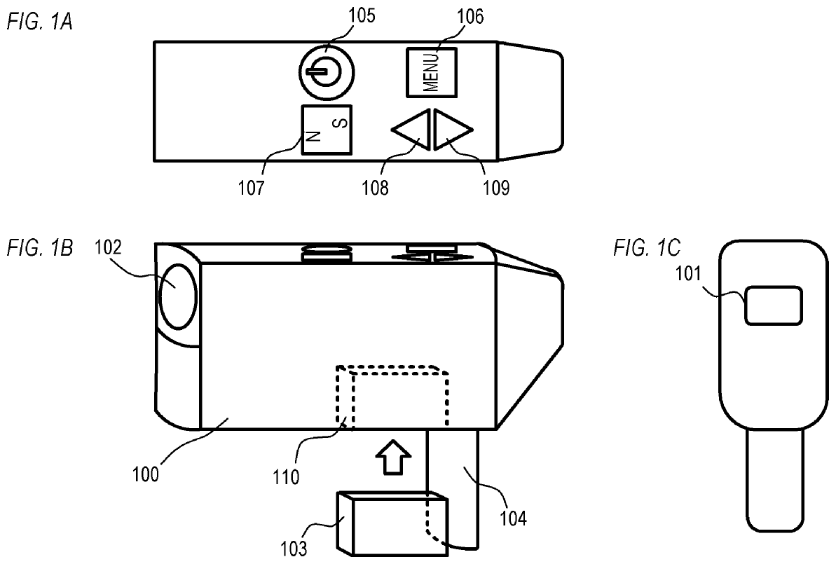

FIG. 1A to FIG. 1C are external-view diagrams of a camera 100 (digital camera) as an example of an electronic device to which the present invention can be applied. FIG. 1A is a top-view diagram, FIG. 1B is a perspective-view diagram, and FIG. 1C is a rear-view diagram. Herein EVF 101 (display) is an eyepiece EVF (Electric View Finder). The EVF 101, which displays captured images and various information items, herein displays a GUI (Graphical User Interface) of a live view during image capture, various information items and a setting screen. An imaging lens unit 102 includes a zoom lens and a focus lens protected by a barrier member, and actuators for driving the lenses. The imaging lens unit 102 optically controls the imaging angle of view according to an operation by the user. A recording medium 103 is a recording medium such as a memory card or a hard disk. A recording medium slot 110 is a slot for storing the recording medium 103. Communication with the camera 100 is possible when the recording medium 103 is stored in the recording medium slot 110. A lid 104 is a lid of the recording medium slot 110.

A power switch 105 is an operation unit for switching powering the camera 100 on and off. Further, a MENU button 106 is an operation unit for switching the menu display on and off. A shutter button 107 is an operation unit for instructing imaging. The shutter button 107 is an operation unit that doubles also as a next button for instructing a subsequent operation. The shutter button 107 functions as a shutter button when the menu display is off (live view display state), and functions as a next button when the menu display is on. Further, a Zoom tele button 108 is an operation unit for instructing telephoto zooming (telephoto side), and a Zoom wide button 109 is an operation unit for instructing wide-angle zooming (wide-angle side).

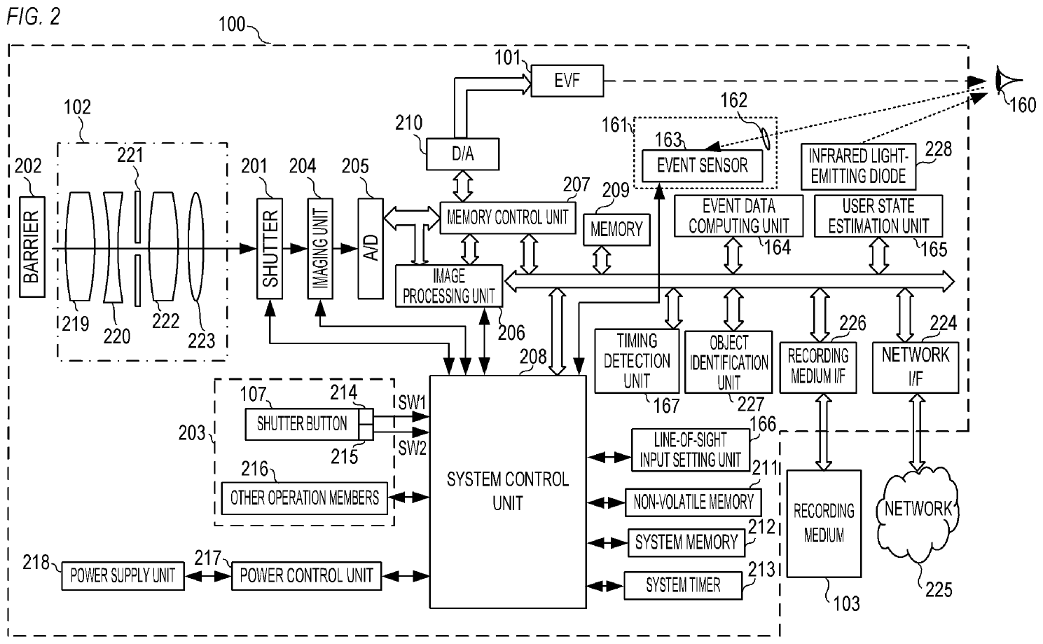

FIG. 2 is a block diagram illustrating a configuration example of the camera 100. The imaging lens unit 102 includes a first group fixed lens 219, a zoom lens 220, an aperture 221, a third group fixed lens 222 and a focus lens 223. The zoom lens 220 is driven by a DC motor (zoom motor) as an actuator, the drive amount being measured by an encoder. The aperture 221 is driven by an actuator, the drive amount being measured by an encoder. The focus lens 223 has both a focus function and a function of a compensator lens that corrects the movement of the focal plane accompanying driving of the zoom lens 220. The focus lens 223 is driven by a pulse motor (focus motor) as an actuator, the drive amount being measured by an encoder.

The shutter 201 controls the exposure time of the imaging unit 204 under the control of a system control unit 208. A barrier 202 is a barrier member that prevents soiling or damage to the imaging system including the imaging lens unit 102, the shutter 201, and the imaging unit 204.

The imaging unit 204 is an imaging element (image sensor), made up of a CCD, a CMOS device or the like, that converts optical images to electrical signals. The A/D converter 205 is used for the purpose of converting analog signals outputted from the imaging unit 204 to digital signals. Unlike a below-described event sensor 163, which is an event-based vision sensor (asynchronous event-based sensor), the imaging unit 204 is a synchronous frame-based sensor.

The image processing unit 206 performs predetermined processing (pixel interpolation, resizing processing such as enlargement or reduction, color conversion processing and so forth) on data from the A/D converter 205 or data from the memory control unit 207. The image processing unit 206 also performs predetermined computation processing using captured image data. The system control unit 208 performs exposure control and ranging control on the basis of the calculation result obtained by the image processing unit 206. In consequence there are performed TTL (through-the-lens)-based AF (autofocus) processing, AE (automatic exposure) processing, and EF (flash pre-emission) processing. The image processing unit 206 further performs predetermined computation processing using the captured image data, and performs TTL-based AWB (auto white balance) processing on the basis of the obtained computation result.

The memory control unit 207 controls transmission and reception of data between the A/D converter 205, the image processing unit 206 and the memory 209. Output data from the A/D converter 205 is written to the memory 209 via the image processing unit 206 and the memory control unit 207, or via the memory control unit 207, bypassing the intervening image processing unit 206.

The system control unit 208, which is a control unit made up of at least one processor or circuit, controls the camera 100 as a whole. The system control unit 208 executes programs recorded on a non-volatile memory 211, to thereby implement the various processing described below. The system control unit 208 controls display by controlling the memory 209, the D/A converter 210, the EVF 101 and so forth.

The memory 209 stores image data obtained by the imaging unit 204 and converted to digital data by the A/D converter 205, and image data for display on the EVF 101. The memory 209 has sufficient storage capacity to store a predetermined number of still images, a predetermined time of moving images, and sound. The memory 209 also doubles as a memory for image display (video memory).

The D/A converter 210 converts data for image display, stored in the memory 209, to analog signals, and supplies these to the EVF 101. The image data for display written in the memory 209 is displayed by the EVF 101, via the D/A converter 210. The EVF 101, which is a display such as an LCD, performs display according to the analog signals from the D/A converter 210. The digital signals resulting from A/D conversion by the A/D converter 205 and stored in the memory 209 are subjected to analog conversion in the D/A converter 210, and are thereupon displayed by being sequentially transferred to the EVF 101, to enable live view display (through-the-lens image display) as a result.

The non-volatile memory 211 is an electrically erasable/recordable memory; for instance an EEPROM or the like is used herein as the non-volatile memory 211. The non-volatile memory 211 stores for instance constants and programs for the operation of the system control unit 208. The term program denotes herein a program for executing various below-described flowcharts in the present embodiment.

The system control unit 208 deploys for instance constants and variables for operation of the system control unit 208, and programs and the like read from the non-volatile memory 211, in a system memory 212 which is for instance a RAM. A system timer 213 is a timing unit that measures the time used in various controls, and the time of a built-in clock.

An operation unit 203 is an input unit that receives an operation from the user (user operation), and is used in order to input various operation instructions to the system control unit 208. The operation unit 203 includes for instance the shutter button 107 and other operation members 216. Other operation members 216 include for instance the power switch 105, the MENU button 106, the Zoom tele button 108 and the Zoom wide button 109. Upon notification that the MENU button 106 has been pressed, the system control unit 208 transitions, in the live view display state, to a menu display-on state, and displays, on the EVF 101, a menu screen on which various settings can be performed. The user can intuitively perform various settings such as instructing selection items using the menu screen displayed on the EVF 101 and the operation unit 203. When in the menu display-on state pressing of the MENU button 106 is notified, the system control unit 208 performs control so as to return to the live view display state.

The shutter button 107 has a first shutter switch 214 and a second shutter switch 215. The first shutter switch 214 is turned on upon so-called half-pressing of the shutter button 107 provided on the camera 100 (imaging preparation instruction) halfway during the operation of the shutter button 107, and generates a first shutter switch signal SW1. The system control unit 208 initiates an imaging preparation operation including AF (auto focus) processing, AE (auto exposure) processing, AWB (auto white balance) processing and EF (flash pre-emission) processing, according to a first shutter switch signal SW1.

The second shutter switch 215 turns on upon completion of the operation of the shutter button 107, i.e. upon so-called full pressing (imaging instruction) of the shutter button 107, and generates a second shutter switch signal SW2. In response to the second shutter switch signal SW2, the system control unit 208 initiates a series of imaging processing operations, from reading of a signal from the imaging unit 204 up to writing image data to the recording medium 103, with captured images in the form of image files.

A power control unit 217, which is made up for instance of a battery detection circuit, a DC-DC converter, a switch circuit for switching between blocks that are to be energized, detects whether a battery is fitted or not, the type of the battery, and the battery level. The power control unit 217 controls the DC-DC converter on the basis of the detection result by the power control unit 217 and on the basis of an instruction from the system control unit 208, and supplies necessary voltage, for a necessary period, to each unit including the recording medium 103. A power supply unit 218 may be for instance made up of a primary battery such as an alkaline battery or a lithium battery, a secondary battery such as a NiCd battery, NiMH battery or Li battery, or may be made up of an AC adapter.

A network interface 224 communicates with a network 225 such as a LAN (Local Area Network) or the interne, on the basis of an instruction from the system control unit 208. During communication, the system control unit 208 can transmit image data for display, written in the memory 209, to an external display device via the network interface 224. Information may also be received via the network interface 224.

A recording medium interface 226 is a communication interface with the recording medium 103 such as a memory card or hard disk. The recording medium 103 is a recording medium for recording captured images, and is for instance made up of a semiconductor memory or a magnetic disk.

An object identification unit 227 analyzes the image data obtained by the imaging unit 204, to identify the type of the object. The object identification unit 227 can also identify the size of the object on the image, and the position of the object on the image. The object identification unit 227 performs the above processing for instance using a convolutional neural network widely resorted to in image recognition.

An eyeball detection unit 161 made up of an eyeball detection lens 162, the event sensor 163 and an event data computing unit 164, is capable of acquiring eyeball information pertaining to the state of an eye 160 of a user peering through a finder.

Infrared light emitted from an infrared light-emitting diode 228 is reflected by the user's eyeball, whereupon the reflected infrared light passes through the eyeball detection lens 162 and forms an image on an imaging surface of the event sensor 163.

The event sensor 163 is an event-based vision sensor that detects changes in the brightness of light that strikes the pixels, and outputs information about pixels the brightness of which has changed, asynchronously with that of other pixels. The data outputted from the event sensor 163 includes for instance position coordinates of pixels in which a brightness change (event) has occurred, the polarity (positive or negative) of the brightness change, and timing information corresponding to the event occurrence time. This data will be referred to hereafter as event data. As compared with a synchronous frame-based sensor such as that of an existing imaging unit 204, the event sensor 163 is characterized by eliminating redundancy in information that is outputted, and affords thereby a high-speed operation, a high dynamic range and low power consumption. On the other hand, event data (information on pixels the brightness of which has changed) is outputted asynchronously with that of other pixels, and hence special processing is required in order to determine associations between event data. In order to determine associations between event data it is necessary to accumulate event data outputted from the event sensor 163 in a predetermined time, and to perform various kinds of computation processing on the result.

The event data computing unit 164 is a computing unit for acquiring (detecting) eyeball information on the basis of event data continuously and asynchronously outputted from the event sensor 163. For instance the event data computing unit 164 acquires eyeball information by accumulating event data occurring during a predetermined time, and processing the accumulated event data as a chunk of data. Multiple eyeball information items having dissimilar occurrence speeds can be acquired by modifying the accumulation time for accumulation of event data.

The eyeball information includes for instance line-of-sight (gaze) position information pertaining to the line-of-sight position (position towards which the user is looking), saccade information pertaining to the direction and speed of saccades, and microsaccade information including the frequency of occurrence and magnitude (amplitude) of microsaccades. The eyeball information may include for instance information pertaining to eyeball movements other than saccades and microsaccades, pupil information pertaining to the size and changes in the size of the pupil, and blinking information pertaining to the speed of blinking and number of blinks. These information items are merely illustrative examples, and the eyeball information is not limited thereto. The event data computing unit 164 may perform image processing through mapping of the event data for the accumulation time as one frame of image data on the basis of the event occurrence coordinates (position coordinates of the pixel in which a brightness change (event) has occurred). Such a configuration allows acquiring eyeball information from image data of one frame obtained through mapping of event data for an accumulation time, by frame-based image processing.

A user state estimation unit 165 is an estimation unit that estimates the state of the user on the basis of the eyeball information obtained by the event data computing unit 164. For instance the size (width) of a gaze area or a degree of gaze (degree of whole-view stare) can be estimated on the basis of the frequency and amplitude of microsaccades. The term gaze area is synonymous with an attention area or focus area. The degree of gaze is an index the value of which increases with decreasing width of the gaze area, and decreases with increasing width of the gaze area. The degree of whole-view stare is defined as the antonym of the degree of gaze. A degree of focus (state of focus) or a degree of tiredness of the user can be estimated on the basis of the frequency and amplitude of microsaccades, pupil size and variation thereof, and the speed and number of blinks. A degree of excitement of the user is related to the frequency of occurrence and speed of microsaccades, and to pupil diameter, and can be estimated on the basis of these parameters. For instance the degree of excitement is an index that increases in a case where the user is looking at an object (pleasing face or the like) with a high degree of liking, and decreases in a case where the user is looking at an object with a low degree of liking. The user state estimation unit 165 can be configured for instance out of a neural network that receives inputs in the form of eyeball information and parameters pertaining to identification results by the object identification unit 227, such that the neural network outputs information pertaining to the state of the user (hereafter referred to as user state information). However, the configuration of user state estimation unit 165 is not limited to the configuration above. The eyeball information used in the user state estimation unit 165 and the estimation result by the user state estimation unit 165 are not limited to those described above.

A line-of-sight input setting unit 166 sets enabling/disabling of processing by the eyeball detection unit 161, via the system control unit 208. The line-of-sight input setting unit 166 can also set parameters and conditions pertaining to processing by the event data computing unit 164 and the user state estimation unit 165. For instance the user can arbitrarily perform these settings through a menu screen or the like.

The system control unit 208 can obtain information about which area of the EVF 101, and to which size, the captured object is to be displayed. The eyeball detection unit 161 can also obtain information as to which area of the EVF 101 the line of sight (gaze) of the user is directed at. As a result, this allows the system control unit 208 to determine which area of the object the user is looking at.

A timing detection unit 167 detects a recording timing which is the timing of recording of a highlight (image (still image or moving image) of a highlight scene). The timing detection unit 167 detects a recording timing on the basis of the eyeball information obtained by the event data computing unit 164 or the state of the user as estimated by the user state estimation unit 165. For instance the timing detection unit 167 detects, as the recording timing, the timing at which there is satisfied a predetermined condition, such as the timing at which the value of the eyeball information or the user state information lay within a given range or the timing at which that value changed by a certain amount. The timing detection unit 167 may factor in time-related conditions to detect, as the recording timing, for instance the timing at which the value of the eyeball information or the user state information lay within a given range for a certain period of time, or the timing at which that value changed by a certain amount. The predetermined condition may be a complex combination of eyeball information or user state information.

For instance the predetermined condition is satisfied in a case where the degree of excitement of the user exceeds a certain value, or when the size of the gaze area of the user is below a certain value and the speed of saccades is above a certain value. The predetermined condition is set by the system control unit 208. The system control unit 208 may set a condition stored in the system memory 212, or may set a condition designated by the user. The predetermined condition may include multiple conditions. The predetermined condition is not limited to those described above. The eyeball information or user state information used for detecting the recording timing is not limited to those described above.

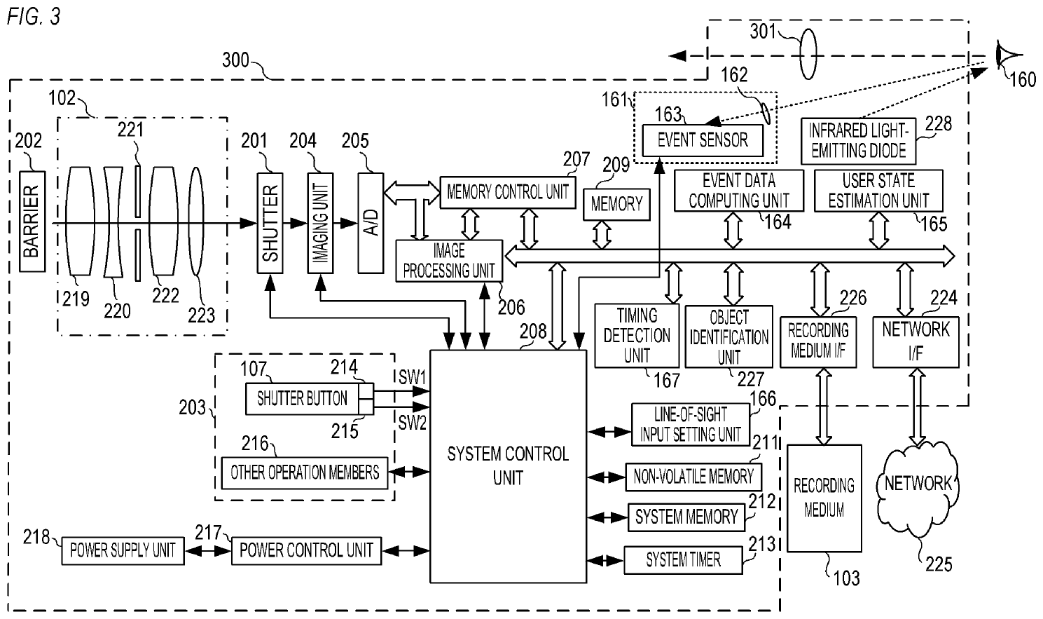

FIG. 3 is a block diagram illustrating a configuration example of smart glasses 300. In Embodiment 1 an instance is exemplified in which the present invention is applied to the camera 100, but the present invention may be applied to a spectacle-type electronic device (wearable-type electronic device) such as the smart glasses 300. The smart glasses 300 capture an area corresponding to the field of view of the user, and record, as a highlight, an image corresponding to the field of view of the user. The user looks in the EVF 101 of the camera 100 in FIG. 2; herein, the user sees the outside world through a lens 301 in the smart glasses 300 in FIG. 3. The focal length of the lens 301 differs for each user, and is set so as to enable the user to focus.

The present invention may also be applied for instance to electronic telescopes (binoculars or monoculars). Also in electronic devices lacking recording capacity to record moving images of several tens of minutes it is however possible to record scenes that the user wants to re-watch, through recording of highlights in accordance with the state of the user.

Setting Processing of a Highlight Recording Flag

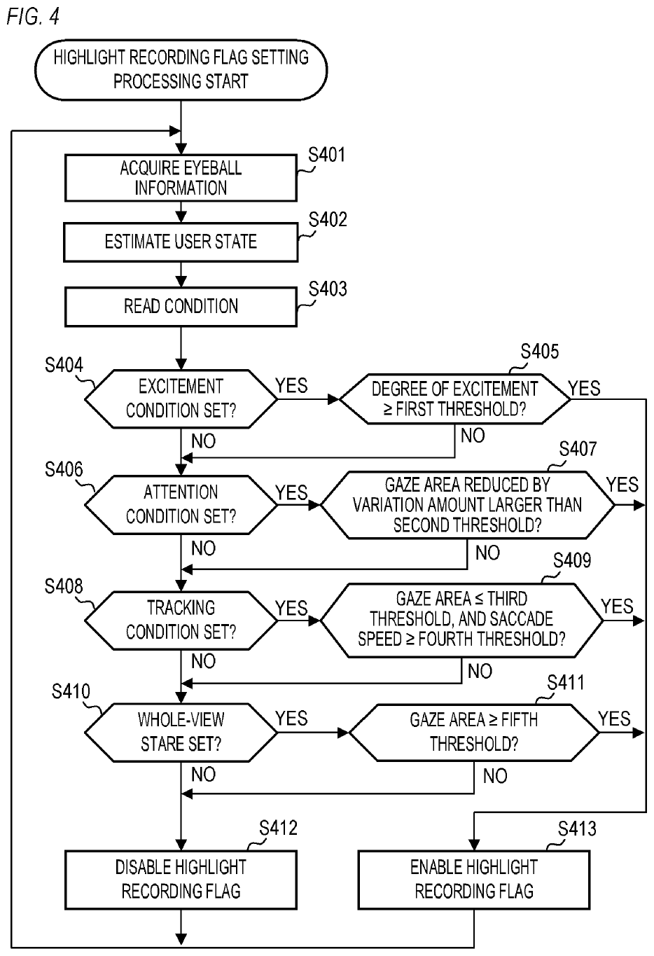

An explanation follows next, with reference to FIG. 4, on a setting processing for setting a highlight recording flag which is a flag denoting a recording timing of a highlight. FIG. 4 is a flowchart illustrating setting processing. The system control unit 208 deploys in the system memory 212, and executes, a program stored in the non-volatile memory 211, and controls various functional blocks, to thereby realize the various processing in the flowchart of FIG. 4. For instance the setting processing starts upon power-on of the camera 100.

In step S401 the system control unit 208 controls the event data computing unit 164 so as to acquire the eyeball information of the user looking at an image displayed on the EVF 101. The eyeball information in step S401 includes the frequency of occurrence of microsaccades, the amplitude (magnitude) of microsaccades, and the speed of saccades. The eyeball information may include other information such as pupil diameter. When the user looks at the image displayed on the EVF 101, the area of the image displayed on the EVF 101, i.e. the area of the image captured by the imaging unit 204, corresponds to the area of the field of view of the user.

In step S402 the system control unit 208 controls the user state estimation unit 165 so as to estimate the state of the user on the basis of the eyeball information acquired in step S401.

In step S403 the system control unit 208 reads a predetermined condition for detecting a recording timing (enabling a highlight recording flag), set in the timing detection unit 167. The following four conditions are assumed in Embodiment 1.

The first one is an excitement (liking) condition (first condition). The excitement condition is a condition aimed at detecting the timing at which the user sees something to his/her liking (something exciting). The second one is an attention condition (second condition). The attention condition aims at detecting the timing at which the user is paying attention. The third one is a tracking condition (third condition). The tracking condition aims at detecting the timing at which the user is focusing on a specific object and is visually tracking the object. The fourth one is a whole-view stare condition (fourth condition). The whole-view stare condition aims at detecting the timing at which the user is whole-view staring (looking at the entire field of view).

In step S404 the system control unit 208 determines whether an excitement condition is set or not. In a case where the excitement condition is set, the system control unit 208 proceeds to step S405, and else proceeds to step S406.

In step S405 the system control unit 208 determines whether the state of the user satisfies the excitement condition or not. The excitement condition is satisfied in a case where the degree of excitement estimated by user state estimation unit 165 in step S402 is equal to or larger than the first threshold value. In a case where the degree of excitement is equal to or larger than to the first threshold value, the system control unit 208 proceeds to step S413, and proceeds to step S406 in a case where the degree of excitement is smaller than the first threshold value.

The user state estimation unit 165 estimates the degree of excitement taking into consideration for instance the frequency of occurrence of microsaccades. The user state estimation unit 165 estimates an increasingly higher value of the degree of excitement as the frequency of occurrence of microsaccades in a predetermined time becomes higher. The user state estimation unit 165 may estimate the degree of excitement taking into consideration for instance an amount of variation in pupil diameter. The user state estimation unit 165 may estimate the value of the degree of excitement as higher the larger is the amount of change in pupil diameter in a predetermined time.

In step S406 the system control unit 208 determines whether an attention condition is set or not. In a case where the attention condition is set, the system control unit 208 proceeds to step S407, and in a case where the attention condition is not set, proceeds to step S408.

In step S407 the system control unit 208 determines whether the state of the user satisfies the attention condition or not. The attention condition is satisfied in a case where the size of the gaze area estimated by the user state estimation unit 165 in step S402 decreases, by a variation amount larger than the second threshold value, in a predetermined time. In a case where the size of the gaze area has decreased by an amount larger than the second threshold value, the system control unit 208 proceeds to step S413, and if the size of the gaze area has not decreased by an amount larger than the second threshold value, proceeds to step S408. In a case where the size of the gaze area is smaller than the predetermined size, the system control unit 208 to proceed to step S413, and in a case where the size of the gaze area is not smaller than the predetermined size, the system control unit 208 performs control so as to proceed to step S408.

The wider the gaze area is, the larger the amplitude of microsaccades and the higher an oscillatory character (lower attenuation rate) tend to be. Also, the wider the gaze area, the higher tends to be the frequency of occurrence of microsaccades in a predetermined time. On the other hand, the narrower the gaze area is, the smaller the amplitude of microsaccade and the lesser the oscillatory character (higher attenuation rate) tends to be. The narrower the gaze area is, the lower the frequency of occurrence of microsaccades in a predetermined time tends to be. Therefore, the size of the gaze area can be estimated on the basis of the amplitude and oscillatory character of microsaccades, and the frequency of occurrence of microsaccades.

In step S408 the system control unit 208 determines whether a tracking condition is set or not. In a case where the tracking condition is set, the system control unit 208 proceeds to step S409, and in a case where the tracking condition is not set, proceeds to step S410.

In step S409 the system control unit 208 determines whether the state of the user satisfies the tracking condition or not. The tracking conditions is satisfied in a case where the size of the gaze area as estimated by the user state estimation unit 165 in step S402 is equal to or smaller than a third threshold value, and the speed of saccades acquired by the event data computing unit 164 in step S401 is equal to or larger than a fourth threshold value. In a case where no saccade is observed, the system control unit 208 may determine that the speed of saccades is not equal to or larger than the fourth threshold value. If the size of the gaze area is equal to or smaller than the third threshold value and the speed of saccades is equal to or larger than the fourth threshold value, the system control unit 208 proceeds to step S413, while in a case where the size of the gaze area is not equal to or smaller than the third threshold value and the speed of saccades is equal to or larger than the fourth threshold value, the system control unit 208 proceeds to step S410. The third threshold value and the fourth threshold value may be absolute values or relative ratios.

In step S410 the system control unit 208 determines whether a whole-view stare condition is set or not. In a case where a whole-view stare condition is set the system control unit 208 proceeds to step S411, and else proceeds to step S412.

In step S411 the system control unit 208 determines whether the state of the user satisfies the whole-view stare condition or not. The whole-view stare condition is satisfied in a case where the size of the gaze area estimated by the user state estimation unit 165 in step S402 is larger than a fifth threshold value for a predetermined time. In a case where the size of the gaze area is larger than the fifth threshold value for the predetermined time, the system control unit 208 proceeds to step S413 and if the size is smaller than the fifth threshold value, proceeds to step S412. The fifth threshold value may be an absolute value or a relative ratio.

In step S412 the system control unit 208 outputs, to the timing detection unit 167, an instruction to disable the highlight recording flag (flag denoting a highlight recording timing).

In step S413 the system control unit 208 outputs, to the timing detection unit 167, an instruction to enable the highlight recording flag. The system control unit 208 repeats the steps S401 to S413 so long as the camera 100 is powered on. In the example of FIG. 4 the system control unit 208 enables the highlight recording flag in a case where at least one condition is satisfied, but may also enable the highlight recording flag in a case where multiple conditions are satisfied simultaneously.

In the example of FIG. 4 the system control unit 208 relies on the excitement condition, attention condition, tracking condition and whole-view stare condition, but other conditions may be used. For instance the system control unit 208 may rely on a condition pertaining to the degree of focus or degree of tiredness of the user, to enable the highlight recording flag in a case where the above condition is satisfied.

The term degree of focus denotes the degree to which the user is focusing on the object he/she is looking at. The term degree of tiredness is a value such as the reciprocal of the degree of focus, and denotes the degree to which the user is not focused (degree to which the user is tired). The higher the degree of tiredness of the user is, the lower the frequency of occurrence of microsaccades and the higher the frequency of blinking tend to be. Therefore, the degree of tiredness can be estimated for instance on the basis of the frequency of occurrence of microsaccades and the frequency of blinking. The system control unit 208 may perform control to enable the highlight recording flag for instance in a case where the degree of tiredness is equal to or larger than a sixth threshold value. For instance the system control unit 208 may perform control so as to enable the highlight recording flag in a case where it is estimated that the state of the user has changed over from being tired to being focused.

For instance the system control unit 208 calculates in step S405 the degree of excitement on the basis of the frequency of occurrence of microsaccades, and switches steps depending on whether the degree of excitement is larger than the first threshold value or not; however, the system control unit 208 is not limited thereto. For instance the system control unit 208 may determine whether the user is looking at something to his/her liking or not on the basis of the frequency of occurrence of microsaccades, without calculating the degree of excitement. The system control unit 208 may also calculate parameters (degree of gaze, degree of focus, degree of tiredness, degree of whole-view stare and so forth) other than the degree of excitement, and switch steps depending on whether the calculated parameter is larger than a threshold value or not. The system control unit 208 may determine whether the user is paying attention or not, and whether the user is focused or not, on the basis of the frequency of occurrence of microsaccades, without calculating the degree of gaze, degree of focus, degree of tiredness or degree of whole-view stare. As described above, the degree of gaze is an indicator such that the narrower the gaze area, the higher the degree of gaze is, and the wider the gaze area, the lower the degree of gaze is; the degree of whole-view stare is thus antonymous to the degree of gaze.

The recording timing of a highlight can be detected on the basis of the state of the user, by setting the highlight recording flag as described above.

Recording Processing of a Highlight Still Image

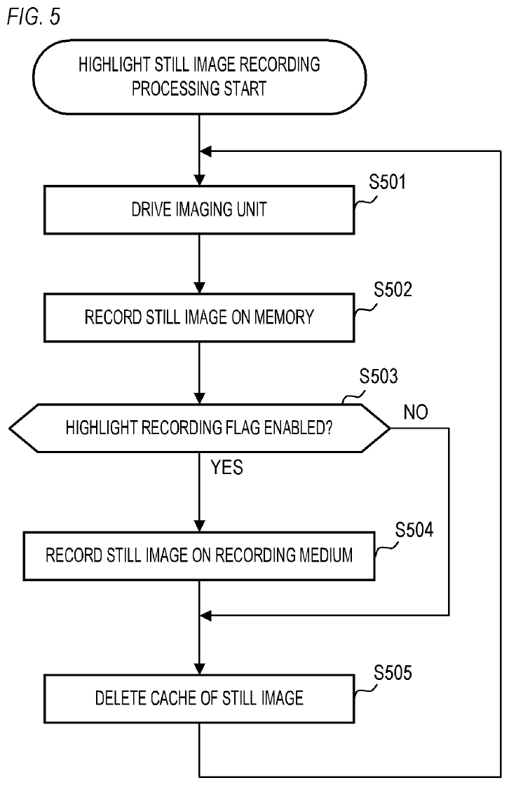

Recording processing for recording a highlight still image will be explained next with reference to FIG. 5. FIG. 5 is a flowchart illustrating recording processing of a highlight still image. The system control unit 208 deploys in the system memory 212, and executes, a program stored in the non-volatile memory 211, and controls various functional blocks, to thereby realize the various processing in the flowchart of FIG. 5. For instance the recording processing starts upon power-on of the camera 100.

In step S501 the system control unit 208 drives the imaging unit 204 (image sensor) so as to output an analog signal.

In step S502 the system control unit 208 causes the A/D converter 205 to convert the analog signal outputted from the imaging unit 204 in step S501 to a digital signal. The system control unit 208 records the digital signal in the memory 209 as still image data (image data) via the image processing unit 206 or memory control unit 207.

In step S503 the system control unit 208 determines whether the highlight recording flag is enabled or not. In a case where the highlight recording flag is enabled, the system control unit 208 proceeds to step S504, and if the flag is disabled proceeds to step S505.

In step S504 the system control unit 208 records, onto the recording medium 103, the still image data recorded on the memory 209.

In step S505 the system control unit 208 deletes the cache of still image data recorded on the memory 209. After deletion of the cache of the still image data, the system control unit 208 returns to step S501 and repeats the processing.

As described above, the camera 100 can record a highlight still image in the form of a still image at the timing of detection of the highlight recording flag.

Recording Processing of a Highlight Moving Image

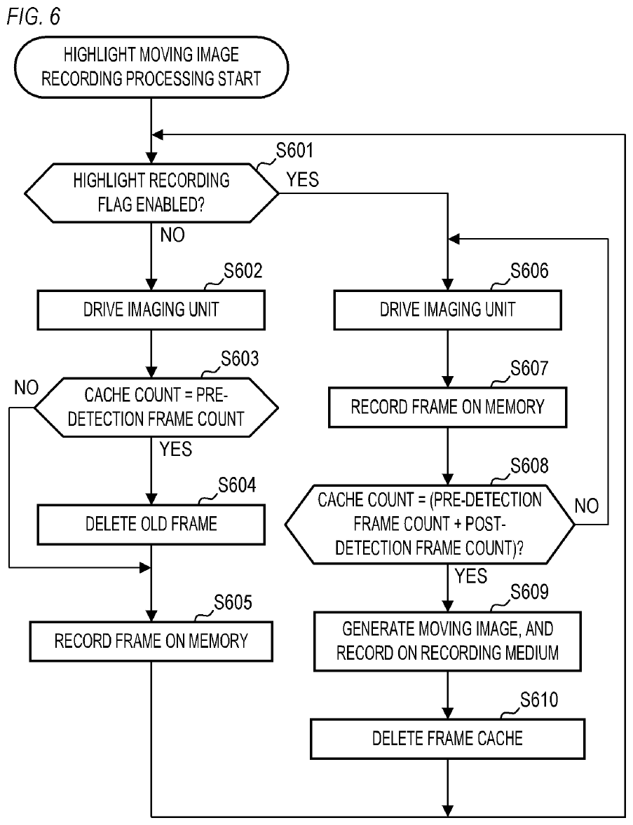

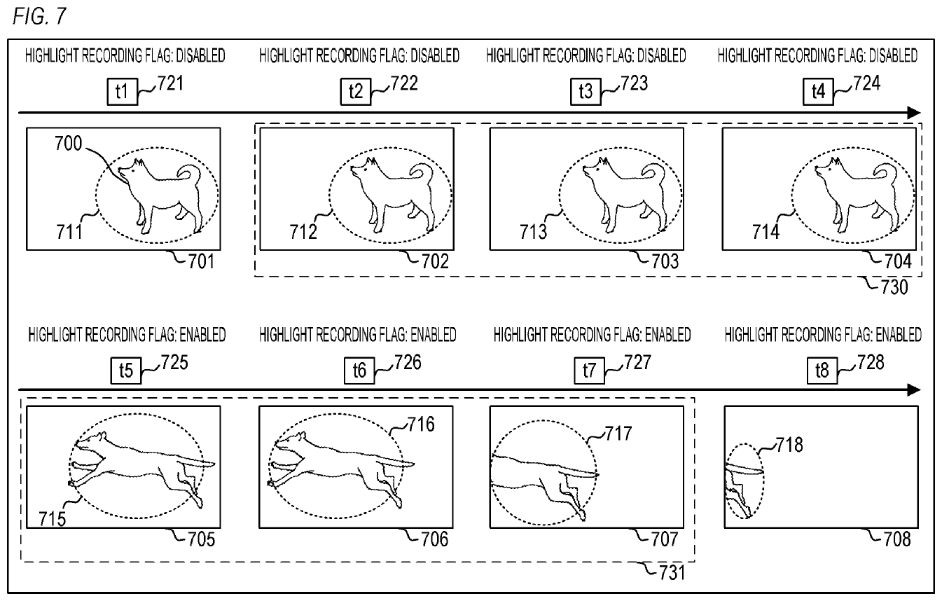

An explanation follows next, with reference to FIG. 6 and FIG. 7, on recording processing for recording a highlight moving image. FIG. 6 is a flowchart illustrating recording processing of a highlight moving image. FIG. 7 is a diagram illustrating an example of a highlight moving image. The system control unit 208 deploys in the system memory 212, and executes, a program stored in the non-volatile memory 211, and controls various functional blocks, to thereby realize the various processing in the flowchart of FIG. 6. For instance the recording processing starts upon power-on of the camera 100. The processing in step S601 is identical to the processing in step S503. The processing in steps S602 and S606 is identical to the processing in step S501. The processing in steps S605 and S607 is identical to the processing in step S502.

In step S603 the system control unit 208 compares the number of frames (images) cached in the memory 209 and a pre-detection frame count set in the system memory 212. In a case where the number of cached frames and the pre-detection frame count match each other, the system control unit 208 proceeds to step S604 and else proceeds to step S605.

The system control unit 208 performs control so that a certain number of frames are cached in the memory 209 for the purpose of recording, as a highlight moving image, a moving image for a predetermined period of time including the timing at which the highlight recording flag is enabled. In FIG. 6, the moving image for the predetermined period of time includes frames before and after the timing at which the highlight recording flag is enabled. The frame preceding the timing at which the highlight recording flag is enabled, from among the frames included in the highlight moving image, will be referred to hereafter as a pre-detection frame. The pre-detection frame count above is the number of pre-detection frames. Among the frames included in the highlight moving image, those frames from the timing at which the highlight recording flag is enabled onwards will hereafter be referred to as post-detection frames, and the post-detection frame count will be referred to as a post-detection frame count. The pre-detection frame count and post-detection frame count, which are modifiable, are set in the system memory 212 by the system control unit 208. The pre-detection frame count and the post-detection frame count may be values that can be designated by the user. The pre-detection frame count and the post-detection frame count frames may take on identical or dissimilar values.

In step S604 the system control unit 208 deletes the oldest frame from among the frames cached in the memory 209. The system control unit 208 maintains thereby a state in which a certain number of frames, including a latest frame, are cached in the memory 209.

In step S608 the system control unit 208 compares the number of frames cached in the memory 209 and the total number of frames of the highlight moving image (total of pre-detection frame count plus post-detection frame count set in the system memory 212). The system control unit 208 repeats the steps S606 and S607 until the number of cached frames and the total number of frames of the highlight moving image match each other, and proceeds thereupon to step S609.

In step S609 the system control unit 208 generates moving image data from data on multiple frames (image data) cached in the memory 209, and records the generated data on the recording medium 103.

In step S610 the system control unit 208 deletes the image data cached in the memory 209. After terminating the step S610 or step S605, the system control unit 208 returns to step S601, and repeats the recording processing.

Upon recording of a highlight moving image of a predetermined number of frames on the recording medium 103, in the example of FIG. 6 the system control unit 208 deletes the image data cached in the memory 209 (steps 5608 to S610). For instance the system control unit 208 caches the image data until the free capacity of the memory 209 reaches a predetermined capacity; the image data cached in the memory 209 may be deleted once the free capacity of the memory 209 drops below the predetermined capacity. As a result, control can be performed so that not only a frame after the highlight recording flag is enabled, but also a frame prior thereto, are included in the highlight moving image, even when the highlight recording flag is repeatedly enabled and disabled.

Once the number of cached frames and the total number of frames of the highlight moving image match each other, the system control unit 208 generates a highlight moving image, and records the generated highlight moving image on the recording medium 103 (steps 5608 and S609). The system control unit 208 may perform control so that after multiple image groups have been stored in the memory 209, multiple highlight moving images corresponding to respective image groups are generated collectively and are recorded on the recording medium 103.

An example of a highlight moving image will be explained next with reference to FIG. 7. As an example, in FIG. 7 the highlight recording flag is enabled in a case where the tracking condition is satisfied (in a case where the size of the gaze area is equal to or smaller than the third threshold value and the speed of saccades is equal to or larger than the fourth threshold value).

An object 700 (a dog in FIG. 7) appears in frames 701 to 708. Areas 711 to 718 denote the gaze area of the user in frames 701 to 708. The size of the areas 711 to 718 is equal to or smaller than the third threshold value. Frames 701 to 708 are associated with timestamps 721 to 728.

In frames 701 to 704, areas 711 to 714 are detected in substantially a same area. In frames 701 to 704, the system control unit 208 determines that the user is looking at the object 700, but that no saccade has occurred. Therefore, in frames 701 to 704 (timestamps 721 to 724) the system control unit 208 determines that the state of the user does not satisfy the tracking condition, and disables the highlight recording flag (step S412).

In frame 705, the object 700 has moved, and accordingly the area in which the gaze area is detected moves from area 714 in frame 704 to area 715 in frame 705. In frame 705, the system control unit 208 determines that the speed of the generated saccades is equal to or larger than the fourth threshold value. Therefore, in frame 705 (time stamp 725), the system control unit 208 determines that the state of the user satisfies the tracking condition, and enables the highlight recording flag (step S413).

As an example, in FIG. 7 the pre-detection frame count and the post-detection frame count are both three. Frames 702 to 704 are frames cached in the memory 209 (three frames immediately preceding frame 705 in which the highlight recording flag is enabled) as pre-detection frames 730. Frames 705 to 707 are frames (three frames, from frame 705 onwards, in which the highlight recording flag becomes enabled) cached in the memory 209 as post-detection frames 731. The system control unit 208 records the pre-detection frames 730 and the post-detection frames 731 together as the highlight moving image, on the recording medium 103 (step S609). As described above, the camera 100 can record a highlight moving image in a predetermined period of time including the timing at which the highlight recording flag is enabled.

The system control unit 208 may associate a frame having an enabled highlight recording flag with the pre-detection frames 730 and the post-detection frames 731, and record the associated frames as still images, on the recording medium 103.

The system control unit 208 may perform setting processing of the highlight recording flag illustrated in FIG. 4, in response to detection of the user's gaze, but may perform the setting processing of the highlight recording flag in response to initiation of moving image recording. In the case of moving image recording, information corresponding to a highlight recording flag may be recorded mapped to frames. This allows the user to select frames with enabled highlight recording flag, from among a plurality of frames in the moving image. For instance the user select a frame with enabled highlight recording flag after recording of a moving image, to generate a highlight still image or a highlight moving image. At the time of playback of the moving image, the user may select (designate) frames with an enabled highlight recording flag, whereupon the selected frames are played back. As a result it becomes possible to specify and play back a scene that the user deems exciting, such as a soccer shoot scene, or to fast-forward up to an exciting scene and play that scene back.

In Embodiment 1 the camera 100 estimates the state of the user on the basis of eyeball information of the user. The camera 100 records a highlight in a case where the estimated state of the user satisfies a predetermined condition. As a result, highlights can be recorded on the basis of the state of the user.

### Embodiment 2

Embodiment 2 explains an example in which the present invention is applied to a head-mounted display (HMD). When the user is focusing on the content displayed on a head-mounted display, it is difficult for the user to designate a scene from which a highlight is to be recorded. The present invention is therefore applied to head-mounted displays. As a result, highlights can be automatically recorded in accordance with the state of the user even if the user is focusing on content displayed on the head-mounted display. Hereafter items shared with Embodiment 1 will be omitted, and mainly those items differing from those in Embodiment 1 will be explained.

Configuration Description

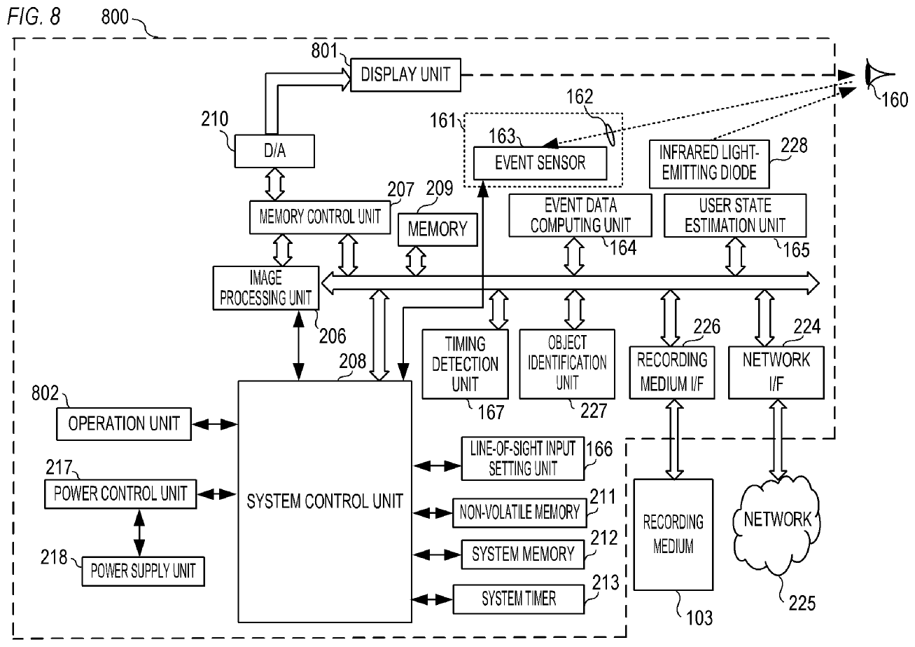

FIG. 8 is a block diagram illustrating a configuration example of a head-mounted display. A display unit 801 is a display unit (display) that displays information to a user wearing a head-mounted display 800.

Display information displayed on the display unit 801 is read into the memory 209 from the recording medium 103 via the recording medium interface 226, or from the network 225 via the network interface 224. The system control unit 208 controls the display unit 801 so as to display content such as still images and moving images included in the display information that is read into the memory 209. When the user looks at an image (still image or moving image) displayed on the display unit 801, the area of the image displayed on the display unit 801, i.e. the area of the image controlled, by the system control unit 208 so as to be displayed on the display unit 801, corresponds to the area of the field of view of the user.

An operation unit 802 is an input unit that receives an operation (user operation) from the user, and is used for inputting various operation instructions to the system control unit 208.

A method for detecting a recording timing on the basis of eyeball information of the user and the state of the user, in the head-mounted display 800, is identical to the detection method in the camera 100 explained with reference to FIG. 4, and an explanation of the method will be omitted herein.

Recording Processing of a Highlight Still Image

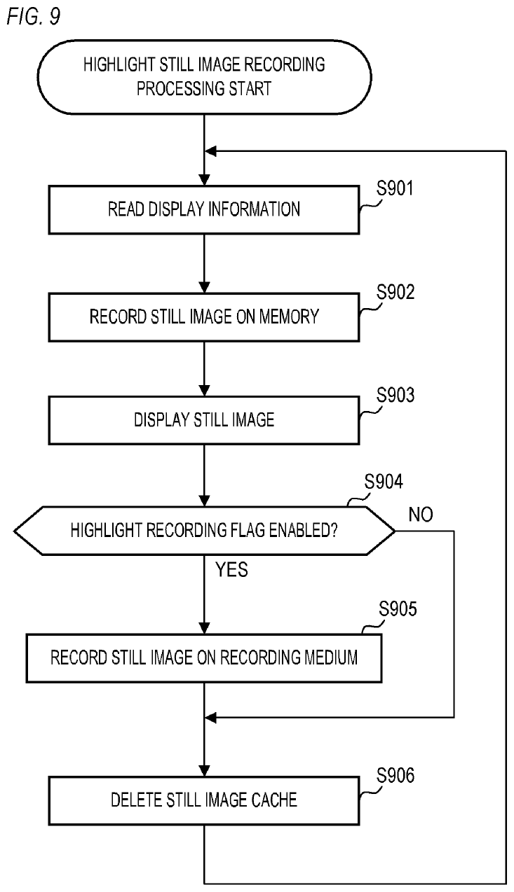

Recording processing for recording a highlight still image will be explained next with reference to FIG. 9. FIG. 9 is a flowchart illustrating recording processing of a highlight still image. The system control unit 208 deploys in the system memory 212, and executes, a program stored in the non-volatile memory 211, and controls various functional blocks, to thereby realize the various processing in the flowchart of FIG. 9. For instance the recording processing starts when the head-mounted display 800 is powered on. The recording processing may start once the user puts on the head-mounted display 800.

In step S901 the system control unit 208 reads display information from the recording medium 103 via the recording medium interface 226, or from the network 225 via the network interface 224.

In step S902 the system control unit 208 records, as still image data (image data), the display information read in the memory 209 in step S901.

In step S903 the system control unit 208 displays, on the display unit 801, the still image data recorded on the memory 209 in step S902.

In step S904 the system control unit 208 determines whether the highlight recording flag is enabled or not. In a case where the highlight recording flag is enabled, the system control unit 208 proceeds to step S905, and if the flag is disabled, proceeds to step S906.

In step S905 the system control unit 208 records, onto the recording medium 103, the still image data recorded on the memory 209.

In step S906 the system control unit 208 deletes the cache of still image data recorded on the memory 209. After deletion of the still image data cache, the system control unit 208 returns to step S901 and repeats the processing.

As described above, the head-mounted display 800 can record a highlight still image in the form of a still image at the timing of detection of the highlight recording flag.

Recording Processing of a Highlight Moving Image

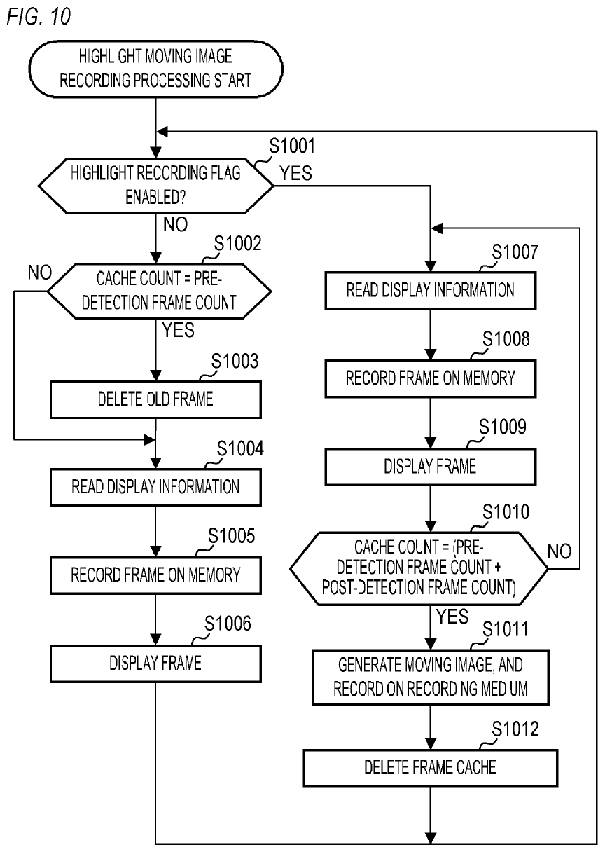

An explanation follows next, with reference to FIG. 10, on recording processing for recording a highlight moving image. FIG. 10 is a flowchart illustrating processing for recording a highlight moving image. The system control unit 208 deploys in the system memory 212, and executes, a program stored in the non-volatile memory 211, and controls various functional blocks, to thereby realize the various processing in the flowchart of FIG. 10. For instance the recording processing starts when the head-mounted display 800 is powered on. The recording processing may start once the user puts on the head-mounted display 800. The processing in step S1001 is identical to the processing in step S904. The processing in steps S1004 to S1006 and processing in steps S1007 to S1009, are identical to processing in steps S901 to S903.

In step S1002 the system control unit 208 compares the number of frames cached in the memory 209 and a pre-detection frame count set in the system memory 212. In a case where the number of cached frames and the pre-detection frame count match each other, the system control unit 208 proceeds to step S1003, and else proceeds to step S1004.

In step S1010 the system control unit 208 compares the number of frames cached in the memory 209 and the total number of frames of the highlight moving image (total of the pre-detection frame count plus the post-detection frame count set in the system memory 212). The system control unit 208 repeats the steps 51007 to 51009 until the number of cached frames and the total number of frames of the highlight moving image match each other, whereupon the system control unit 208 proceeds to step S1011.

In step S1011 the system control unit 208 generates moving image data from multiple frame data (image data) cached in the memory 209, and records the generated data on the recording medium 103.

In step S1012 the system control unit 208 deletes the image data cached in the memory 209. After terminating the step S1006 or S1012, the system control unit 208 returns to step S1001, and repeats the recording processing.

As described above, the head-mounted display 800 can record a highlight moving image during a predetermined period of time including the timing at which the highlight recording flag is detected.

In Embodiment 2 the head-mounted display 800 estimates the state of the user on the basis of eyeball information of the user. The head-mounted display 800 records a highlight in a case where the estimated state of the user satisfies a predetermined condition. As a result, highlights can be recorded on the basis of the state of the user.

The present invention allows thus recording highlights on the basis of the state of the user.

### Other Embodiments

Although the present invention has been described in detail above on the basis of preferred embodiments thereof, the invention is not limited to these concrete embodiments, and encompasses also various implementations that do not depart from the scope of the invention. Parts of the above embodiments may be combined with each other as appropriate.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-201809, filed on Dec. 13, 2021, which is hereby incorporated by reference herein in its entirety.

What is claimed is:

1. An electronic device comprising at least one memory and at least one processor which function as:
an acquisition unit configured to acquire eyeball information of a user; and
a recording unit configured to, on a basis of the eyeball information acquired by the acquisition unit, record an image corresponding to a field of view of the user, in a case where a state of the user satisfies a predetermined condition.

2. The electronic device according to claim 1, wherein
the eyeball information includes at least one of frequency of occurrence of microsaccades, magnitude of microsaccades, gaze position, direction of saccades, speed of saccades, pupil size, amount of change in pupil diameter, blinking speed and blinking frequency.

3. The electronic device according to claim 1, wherein
the at least one memory and the at least one processor further function as: an estimation unit configured to estimate the state of the user on a basis of the eyeball information.

4. The electronic device according to claim 3, wherein
the estimation unit estimates at least one of a degree of excitement, a degree of gaze, a degree of whole-view stare, a degree of focus, and a degree of tiredness.

5. The electronic device according to claim 3, wherein
the estimation unit estimates whether or not the user is in a state of looking at something to his/her liking, and
the recording unit records an image corresponding to the field of view of the user in a case where the state of the user, estimated by the estimation unit, satisfies a first condition on a basis of which it is estimated that the user is in the state of looking at something to the his/her liking.

6. The electronic device according to claim 5, wherein
the estimation unit estimates a degree of excitement of the user, and estimates, on a basis of the degree of excitement, whether or not the user is in the state of looking at something to his/her liking, and
the first condition is satisfied in a case where the degree of excitement estimated by the estimation unit is equal to or larger than a first threshold value.

7. The electronic device according to claim 3, wherein
the estimation unit estimates whether the user is paying attention or not, and
the recording unit records an image corresponding to the field of view of the user in a case where the state of the user, estimated by the estimation unit, satisfies a second condition on a basis of which a state is estimated of being paying attention.

8. The electronic device according to claim 7, wherein
the estimation unit estimates a size of a gaze area of the user, and estimates, on a basis of a change in the size, whether the user is paying attention or not, and
the second condition is satisfied in a case where the size of the gaze area, estimated by the estimation unit, decreases by an amount of change which is larger than a second threshold value, in a predetermined time.

9. The electronic device according to claim 3, wherein
the estimation unit estimates whether the user is visually tracking a specific object or not, and
the recording unit records an image corresponding to the field of view of the user in a case where the state of the user, estimated by the estimation unit, satisfies a third condition on a basis of which a state is estimated of being visually tracking the specific object.

10. The electronic device according to claim 9, wherein
the estimation unit estimates a size of a gaze area of the user, and estimates, on a basis of the size, whether the user is visually tracking the specific object or not, and
the third condition is satisfied in a case where the size of the gaze area, estimated by the estimation unit, is equal to or smaller than a third threshold value and speed of saccades is equal to or higher than a fourth threshold value.

11. The electronic device according to claim 3, wherein
the estimation unit estimates whether or not the user is in a state of looking at a whole view, and
the recording unit records an image corresponding to the field of view of the user in a case where the state of the user, estimated by the estimation unit, satisfies a fourth condition on a basis of which is estimated a state of being looking at the whole view.

12. The electronic device according to claim 11, wherein
the estimation unit estimates a size of a gaze area of the user, and estimates, on a basis of the size, whether or not the user is in the state of looking at the whole view, and
the fourth condition is satisfied in a case where the size of the gaze area, estimated by the estimation unit, is larger than a fifth threshold value, in a predetermined time.

13. The electronic device according to claim 1, wherein
the recording unit records a plurality of images in a predetermined period of time that includes a timing at which the predetermined condition is satisfied, as an image corresponding to the field of view of the user.

14. The electronic device according to claim 13, wherein
the predetermined period of time includes a timing after the timing at which the predetermined condition is satisfied.

15. The electronic device according to claim 13, wherein
the predetermined period of time includes a timing prior to the timing at which the predetermined condition is satisfied.

16. The electronic device according to claim 1, further comprising:
an image sensor, wherein
the at least one memory and the at least one processor further function as: a control unit configured to perform control so that an image captured by the image sensor is displayed on a display,
the acquisition unit acquires the eyeball information of the user looking at an image captured by the image sensor and displayed on the display, and
the recording unit records the image captured by the image sensor in a case where the state of the user satisfies the predetermined condition.

17. The electronic device according to claim 1, further comprising:
an image sensor configured to capture an area corresponding to the field of view of the user, wherein
the recording unit records the image captured by the image sensor in a case where the state of the user satisfies the predetermined condition.

18. The electronic device according to claim 1, wherein
the at least one memory and the at least one processor further function as: a control unit configured to perform control so as to display a moving image on a display,
the acquisition unit acquires eyeball information of a user looking at the moving image displayed on the display, and
the recording unit records, from among a plurality of frames of the moving image, frames displayed on the display when the state of the user satisfies the predetermined condition.

19. A control method of an electronic device, comprising:
acquiring eyeball information of a user; and
recording an image corresponding to a field of view of the user, in a case where a state of the user satisfies a predetermined condition, on a basis of the eyeball information.

20. A non-transitory computer readable medium that stores a program, wherein the program causes a computer to execute a control method of an electronic device, the control method comprising:
acquiring eyeball information of a user; and
recording an image corresponding to a field of view of the user, in a case where a state of the user satisfies a predetermined condition, on a basis of the eyeball information.
